(19) United States
(12) Patent Application Publication
(10) Pub. No.: US 2024/0381885 A1
(43) Pub. Date: Nov. 21, 2024

(54) STONE FRUIT QUALITY

(71) Applicant: Valent BioSciences LLC, Libertyville, IL (US)

(72) Inventors: Peter D. Petracek, Grayslake, IL (US); Veria Ysabel Alvarado Chavez, Grayslake, IL (US); Steve McArtney, Antioch, IL (US); Hanwei Zhang, Port Barrington, IL (US)

(21) Appl. No.: 18/663,567

(22) Filed: May 14, 2024

Related U.S. Application Data
(60) Provisional application No. 63/502,179, filed on May 15, 2023.

(51) Int. Cl. A23B 7/055; A23B 7/154

(52) U.S. Cl. CPC A23B 7/055; A23B 7/154

(57) ABSTRACT

The present invention is directed to methods of improving cold stress tolerance in a stone fruit comprising applying an effective amount of a mixture of abscisic acid and a jasmonate to the stone fruit. The present invention is further directed to methods of improving fruit quality in stone fruit subjected to chilling temperatures comprising applying an effective amount of a mixture of (S)-abscisic acid and a jasmonate to the stone fruit.

### FIELD OF THE INVENTION

The present invention is directed to methods of improving post-harvest cold stress tolerance in a stone fruit comprising applying an effective amount of a mixture of abscisic acid and a jasmonate to the stone fruit. The present invention is further directed to methods of improving fruit quality in stone fruit subjected to post-harvest chilling temperatures comprising applying an effective amount of a mixture of(S)-abscisic acid and a jasmonate to the stone fruit.

### BACKGROUND OF THE INVENTION

(S)-abscisic acid (“S-ABA”) is an endogenous plant growth regulator with many roles in growth and development. For example, S-ABA inhibits seed germination by antagonizing gibberellins that stimulate the germination of seeds. S-ABA promotes stress tolerance and maintains growth under stress conditions (see Sharp RE et al. J Exp Bot, 2004 55:2343-2351).

Jasmonates are phytohormones derived from cyclic fatty acids and regulates plant defenses to pests and further regulates developmental processes. Methyl jasmonate has been well studied and has been further found to be involved in root growth, growth of reproductive organs and plant senescence.

Stone fruits such as almond, apricot, cherry, nectarine, peach, and plum are important perennial fruit crops in the US and around the world. There is an increasing emphasis on producing fruit of high quality. Growers are now challenged to produce crops with adequate color and optimal flavor as consumers have grown to expect high quality fruit on a year-round basis.

Chilling of the stone fruit can lead to low quality fruit. Specifically, chilling can damage the many fruit qualities that are desired by the consumer such as texture, color, firmness, juiciness, aroma, and flavor. Chilling damage can also lower hedonic scores, which are scores given by consumer taste panel assessments. However, refrigeration is often used to impede ripening and retard fungal growth on stone fruits so that time from harvest to store shelf and store shelf life can be extended as both over ripe fruit and fungal growth are undesirable to the consumer.

Thus, there is a need in the art for a method of improving cold tolerance and improving fruit quality of stone fruits that are subjected to chilling temperatures so that higher quality fruit may be available to the consumer.

### SUMMARY OF THE INVENTION

In one aspect, the present invention is directed to methods of improving post-harvest cold stress tolerance in a stone fruit comprising applying an effective amount of a mixture of(S)-abscisic acid (“S-ABA”) and a jasmonate to the stone fruit.

In another aspect, the present invention is further directed to methods of improving fruit quality in stone fruit subjected to post-harvest chilling temperatures comprising applying an effective amount of a mixture of S-ABA and a jasmonate to the stone fruit.

### DETAILED DESCRIPTION OF THE INVENTION

Applicant unexpected discovered that a mixture of (S)-abscisic acid (“S-ABA”) and a jasmonate synergistically improved post-harvest cold stress tolerance in stone fruit. Further, the Applicant unexpectedly discovered that a mixture of S-ABA and a jasmonate improved fruit quality of stone fruit when the stone fruit is subjected to post-harvest chilling temperatures.

In one embodiment, the present invention is directed to methods of improving post-harvest cold stress tolerance in a stone fruit comprising applying an effective amount of a mixture of S-ABA and a jasmonate to the stone fruit.

In a preferred embodiment, applications of the mixture of the present invention occur from about 4 weeks prior to harvest to about 2 weeks after harvest. In a more preferred embodiment application occurs after harvest.

In another preferred embodiment, the stone fruit is subjected to chilling temperatures following application of the mixture of the present invention, preferably from about 0.5 to about 15 degrees Celsius and more preferably from about 2 to about 10 degrees Celsius and most preferably from about 2.2 to about 7.6 degrees Celsius.

In another preferred embodiment, the quality of the stone fruit is improved as compared to stone fruit that did not receive an application of the mixture of the present prior to being subjected to chilling temperatures.

In another preferred embodiment, the mixture of the present invention may be applied at a concentration ratio of from about 1,000:1 to about 1:1,000 S-ABA to the jasmonate, more preferably from about 500:1 to about 1:500 and even more preferably from about 100:1 to about 1:100, yet even more preferably from about 10:1 to about 1:10 and even more preferably from about 3:1 to about 1:3 and most preferably at about 10:1, about 1:1 or about 1:10.

In another preferred embodiment, S-ABA may be applied at a rate from about 1 to about 5,000 parts per million (“ppm”), more preferably from about 10 to about 1,000 ppm, even more preferably from about 50 to about 1,000 ppm and even more preferably at about 90, about 320 or about 870 ppm.

In another preferred embodiment, the jasmonate may be applied at a rate from about 1 to about 5,000 ppm, more preferably from about 10 to about 1,000 ppm, even more preferably from about 50 to about 1,000 ppm and even more preferably at about 70, about 270 or about 740 ppm.

Jasmonates suitable for use in the subject invention, include but are not limited to, jasmonic acid, methyl jasmonate and prohydrojasmon. In a preferred embodiment, the jasmonate is methyl jasmonate.

In another embodiment, the present invention is directed to methods of improving fruit quality in stone fruit subjected to post-harvest chilling temperatures comprising applying an effective amount of a mixture of S-ABA and a jasmonate to the stone fruit.

The methods of the present invention may exclude the application of nicotinamide.

The methods of the present invention may consist of applying an effective amount of a mixture of S-ABA and a jasmonate as the only agriculturally active ingredients applied.

In a preferred embodiment, the stone fruit are selected from the group consisting of apricot, sweet cherry, tart cherry, nectarine, peach, plum, Chicksaw plum, Damson plum, Japanese plum, plumcot, fresh prune, mangoes and cultivars, varieties and hybrids thereof.

Cultivars, varieties and hybrids of stone fruits may be from a plant which can be produced by natural hybridization, a plant which can occur as the result of a mutation, an F1 hybrid plant, or a transgenic plant (also referred to as a “genetically modified plant”).

The term “F1 hybrid plant” refers to a plant of a first filial generation which is produced by hybridizing two different varieties with each other, and is generally a plant which has a more superior trait to that of either one of parents thereof. The term “transgenic plant” refers to a plant which is produced by introducing a foreign gene from another organism such as a microorganism into a plant and which has a property that cannot be acquired easily by hybridization breeding, induction of a mutation or a naturally occurring recombination under a natural environment.

Examples of the technique for producing the above-mentioned plants include a conventional breeding technique, a transgenic technique, a genome-based breeding technique, a new breeding technique, and a genome editing technique. The conventional breeding technique is a technique for producing a plant having a desirable property by mutation or hybridization. The transgenic technique is a technique for imparting a new property to a specific organism by isolating a gene (DNA) of interest from the organism and then introducing the gene (DNA) into the genome of another target organism, and an antisense technique or an RNA interference technique which is a technique for imparting a new or improved property to a plant by silencing another gene occurring in the plant.

The genome-based breeding technique is a technique for increasing the efficiency of breeding using genomic information, and includes a DNA marker (also referred to as “genome marker” or “gene marker”) breeding technique and genomic selection. For example, the DNA marker breeding is a method in which an offspring having a desired useful trait gene is selected from many hybrid offspring using a DNA marker that is a DNA sequence capable of serving as an indicator of the position of a specific useful trait gene on a genome. The analysis of a hybrid offspring of a plant at a seedling stage thereof using the DNA marker has such a characteristic that it becomes possible to shorten the time required for breeding effectively.

The genomic selection is such a technique that a prediction equation is produced from a phenotype and genomic information both obtained in advance and then a property is predicted from the prediction equation and the genomic information without carrying out the evaluation of the phenotype. The genomic selection can contribute to the increase in efficiency of breeding. A “new breeding technique” is a collective term for a variety of breeding techniques including molecular biological techniques. Examples of the new breeding technique include techniques such as cisgenesis/intragenesis, oligonucleotide-directed mutagenesis, RNA-dependent DNA methylation, genome editing, grafting to a genetically modified rootstock or scion, reverse breeding, agroinfiltration, and seed production technology (SPT). The genome editing technique is a technique that converts genetic information in a sequence-specific manner, and enables addition, deletion and or substitution of a DNA base-pair sequence, addition, deletion and or substitution of an amino acid sequence, introduction of a foreign DNA base-pair sequence including genes and regulatory regions, and the like. Examples of the tool for the technique include zinc-finger nuclease (ZFN), TALEN, CRISPR/Cas9, CRISPER/Cpfl and meganuclease which can cleave DNA in a sequence-specific manner, and a sequence-specific genome modification technique using CAS9 nickase, Target-AID and the like which is produced by any one of the modification of the above-mentioned tools. A skilled artisan would understand that future techniques will be developed that are capable of editing the genomic sequence, modifying transcription of a DNA sequence to an RNA sequence, modifying an RNA sequence, modifying translation of an RNA sequence to an amino acid sequence, modifying an amino acid sequence and or modifying the folding of an amino acid sequence and or agglomeration of amino acid sequences to a protein and that any or all of these techniques may be beneficial in modifying the phenotype of a plant. Plants whose phenotypes have been modified by all known and future techniques capable of modifying the phenotype of a plant are envisaged herein. Examples of the above-mentioned plant parts include parts of plants listed in genetically modified crops registration database (GM APPROVAL DATABASE) in an electric information site in INTERNATIONAL SERVICE for the ACQUISITION of AGRI-BIOTECH APPLICATIONS, ISAAA) (http://www.isaaa.org/).

In a preferred embodiment, the mixtures of the present invention may be disposed in a composition comprising one or more excipients selected from the group consisting of solvents, anti-caking agents, stabilizers, defoamers, slip agents, humectants, dispersants, wetting agents, thickening agents, emulsifiers, penetrants, adjuvants, synergists, polymers, propellants and preservatives.

The mixtures or compositions of the present invention can be applied by any convenient means. Those skilled in the art are familiar with the modes of application including but not limited to, spraying, brushing, soaking, dipping, drenching, granule application, pressurized liquids (aerosols), vapor and fogging. Spraying includes space sprays. Space sprays include aerosols and thermal fog spray. The mixtures and composition may further be mixed with a wax and/or edible coating and applied to the fruit.

The mixtures of the present composition may be applied concurrently or sequentially.

As used herein, the phrase “chilling temperatures” refers to those temperatures below 25 degrees Celsius that cause the quality of the fruit to diminish.

As used herein, the phrase “fruit quality” refers to any feature of the fruit that is desirable by the consumer including, but not limited to, texture, color, firmness, juiciness, aroma, and flavor. “Fruit quality” may also refer to scores on the hedonic scale, which are scores given by consumer taste panel assessments.

As used herein, “effective amount” refers to the amount of the S-ABA and/or a jasmonate that will improve post-harvest cold stress tolerance, and/or fruit quality. The “effective amount” will vary depending on the S-ABA and the jasmonate concentrations, the plant species, variety, cultivar or hybrid being treated, the severity of the stress, the result desired, and the life stage of the plants, among other factors. Thus, it is not always possible to specify an exact “effective amount.” However, an appropriate “effective amount” in any individual case may be determined by one of ordinary skill in the art.

As used herein, “improving” means that the plant has more of the quality than the plant would have had it if it had not been treated by methods of the present invention.

As used herein, all numerical values relating to amounts, weight percentages and the like are defined as “about” or “approximately” each particular value, namely, plus or minus 10% (±10%). For example, the phrase “at least 5% by weight” is to be understood as “at least 4.5% to 5.5% by weight.” Therefore, amounts within 10% of the claimed values are encompassed by the scope of the claims.

The articles “a,” “an” and “the” are intended to include the plural as well as the singular, unless the context clearly indicates otherwise.

The disclosed embodiments are simply exemplary embodiments of the inventive concepts disclosed herein and should not be considered as limiting, unless the claims expressly state otherwise.

The following examples are intended to illustrate the present invention and to teach one of ordinary skill in the art how to use the formulations of the invention. They are not intended to be limiting in any way.

### EXAMPLES

### Example 1—Improved Stone Fruit Quality

### Method

Flamin' Fury® variety Peaches were harvested and maintained at room temperature until treatment. Peaches were divided into 9 equal sets. Each treatment type contained 15 peaches and was repeated 3 times for a total of 45 peaches per treatment. For treatment, water, (S)-abscisic acid (“S-ABA”), methyl jasmonate or a mixture of S-ABA and methyl jasmonate were applied to peaches after harvest via a 1-minute dip at the following concentrations: 1) water only; 2) 0.33 millimolar (“mM”) S-ABA; 3) 3.3 mM S-ABA; 4) 0.33 mM methyl jasmonate; 5) 3.3 mM methyl jasmonate; 6) 0.33 mM S-ABA and 0.33 mM methyl jasmonate; 7) 0.3 mM S-ABA and 3.3 mM methyl jasmonate; 8) 3.3 mM S-ABA and 0.33 mM methyl jasmonate or 9) 3.3 mM S-ABA and 3.3 mM methyl jasmonate. Each treatment includes 0.025% Latron B-1956® (available from J.R. Simplot Company) as an adjuvant. All peaches were subsequently dried for 30 minutes and then stored at 5 degrees Celsius for 4 weeks. Following cold storage all peaches were placed at room temperature for 1 day and then evaluated for flesh browning.

Flesh browning was determined using a 6-point scale developed by Crisosto G.M. 2015 wherein a score of 1=no browning, 2=very slight browning in the pit cavity, 3=slight browning in the pit cavity and surrounding tissue, 4=moderate browning on less than 50% of the flesh, 5=severe browning on 50% to 75% of the flesh and 6=extreme browning covering most of the flesh. A flesh browning score of more than 3 was determined as a “flesh browning incident” and a score of less than 3 was determined as “healthy fruit” for efficacy purposes.

To determine the percent of peaches that did not develop an undesirable amount of flesh browning (i.e. “healthy fruit”) the total number of peaches with a flesh browning score of less than 3 was divided by the total number of peaches per set.

To determine if the mixtures provided unexpected results, the observed combined efficacy (“OCE”) was divided by the expected combined efficacy (“ECE”) wherein the expected ECE is calculated by the Abbott method:

$$ECE = A + B - ( AB ) ,$$

wherein ECE is the expected combined efficacy and in which A and B are the quality score provided by application of the single active ingredients. If the ratio between the OCE of the mixture and the ECE of the mixture is greater than 1, then greater than expected interactions are present in the mixture. (Gisi, Synergistic Interaction of Fungicides in Mixtures, The American Phytopathological Society, 86:11, 1273-1279,1996). Results can be found in Table 1, below.

TABLE 1

| | Active Ingredient | | % Healthy | Fold Change | OCE:ECE |
|---|---|---|---|---|---|
| | Concentration | | Fruit | from Control | Ratio |
| Control | — | | 12.8 | — | — |
| S-ABA | 0.33 | mM | 17.3 | 0.35 | — |
| S-ABA | 3.3 | mM | 8.6 | −0.33 | — |
| MJ | 0.33 | mM | 28.0 | 1.18 | — |
| MJ | 3.3 | mM | 41.8 | 2.26 | — |
| S-ABA | 0.33 | mM | 34.1 | 1.66 | 1.5 |
| MJ | 0.33 | mM | | | |
| S-ABA | 0.33 | mM | 73.5 | 4.73 | 2.6 |
| MJ | 3.3 | mM | | | |
| S-ABA | 3.3 | mM | 43.9 | 2.43 | 1.9 |
| MJ | 0.33 | mM | | | |
| S-ABA | 3.3 | mM | 49.2 | 2.84 | 1.1 |
| MJ | 3.3 | mM | | | |

### Results

As seen in Table 1, above, application of a mixture of S-ABA and methyl jasmonate improved stone fruit quality in a greater than expected amount as compared to the addition of the improved quality provided by application of each alone at each of a 10:1, 1:1 and 1:10 concentration ratio.

### Example 2—Improved Stone Fruit Quality

### Method

Summer Flame 34 variety Peaches were harvested and maintained at room temperature until treatment. Peaches were divided into 4 equal sets. Each treatment type contained 32 peaches and was repeated 3 times for a total of 96 peaches per treatment. For treatment, water, (S)-abscisic acid (“S-ABA”), methyl jasmonate or a mixture of S-ABA and methyl jasmonate were mixed in Prima Fresh 55EU wax and applied in a semicommercial mini packing line to simulate commercial packing conditions. Active ingredients were mixed into the wax at the following concentrations: 1) wax only; 2) 1.2 mM S-ABA; 3) 1.2 mM methyl jasmonate; 4) 1.2 mM S-ABA and 1.2 mM methyl jasmonate. All peaches were immediately stored at 5 degrees Celsius for 25 days. Following cold storage all peaches were placed at room temperature for 3 day and then evaluated for flesh browning as described in Example 1, above and also for flesh mealiness.

Flesh mealiness was determined using a 3-point scale developed by Crisosto G.M. 2015 wherein a score of 1=juicy fruit, 2=moderately mealy fruit (small amount of juice released upon squeezing) and 3=severely mealy fruit (almost no juice released upon squeezing). A flesh mealiness score of 2 or more was determined as a “flesh mealiness incident” and a score of 1 was determined as “healthy fruit” for efficacy purposes.

Determination of unexpected results was calculated using the method described in

Example 1, above. Results can be found in Table 2 for flesh browning and in Table 3 for flesh mealiness, below.

TABLE 2

| | Active | | | |
|---|---|---|---|---|
| | Ingredient | Flesh Browning | Fold Change | OCE:ECE |
| | Concentration | Average Score | from Control | Ratio |
| Control | — | 3.08 | — | — |
| S-ABA | 1.2 mM | 3.03 | −0.016 | — |
| MJ | 1.2 mM | 2.79 | −0.09 | — |
| S-ABA | 1.2 mM | 2.58 | −0.16 | 1.5 |
| MJ | 1.2 mM | | | |

TABLE 3

| | Active | | | |
|---|---|---|---|---|
| Flesh | Ingredient | Flesh Mealiness | Fold Change | OCE:ECE |
| Mealiness | Concentration | Average Score | from Control | Ratio |
| Control | — | 1.67 | — | — |
| S-ABA | 1.2 mM | 1.66 | −0.006 | — |
| MJ | 1.2 mM | 1.50 | −0.10 | — |
| S-ABA | 1.2 mM | 1.39 | −0.17 | 1.5 |
| MJ | 1.2 mM | | | |

### Results

As seen in Tables 2 and 3, above, application of a mixture of S-ABA and methyl jasmonate improved stone fruit quality in a greater than expected amount as compared to the addition of the improved quality provided by application of each alone at a 1:1 and 1:10 concentration ratio.

### Example 3—Improved Mango Quality (Prophetic)

### Method

Mangoes will be harvested and divided into groups for treatment. For treatment, water, (S)-abscisic acid (“S-ABA”), methyl jasmonate or a mixture of S-ABA and methyl jasmonate will be applied to mangoes after harvest via a 1-2 minute dip at the following concentrations: 1) water only; 2) 0.3 millimolar (“mM”) S-ABA; 3) 3 mM S-ABA; 4) 0.3 mM methyl jasmonate; 5) 3 mM methyl jasmonate; 6) 0.3 mM S-ABA and 0.3 mM methyl jasmonate; 7) 0.3 mM S-ABA and 3 mM methyl jasmonate; 8) 3 mM S-ABA and 0.3 mM methyl jasmonate or 9) 3 mM S-ABA and 3 mM methyl jasmonate. Each treatment will include 0.025% Latron B-1956® (available from J.R. Simplot Company) as an adjuvant. All mangoes will be subsequently dried for 30 minutes and then stored at chilling temperatures for one to several weeks. Following cold storage all mangoes will be placed at room temperature for one to several days and then evaluated for chilling injury symptoms.

Visual chilling injury symptoms (lenticel darkening, skin pitting, scalding, uneven ripening) of each individual mango will be assessed before and after transfer from the putative chilling temperatures to ambient temperature using a rating scale in which 1=severe, >50% of the fruit's surface showing damage; 2=moderate, 25-50% chilling damage; 3=slight, up to 25% pitting and/or scalding; 4=trace (small pits), 2-5% of the total fruit surface damaged; 5=no visible symptoms of injury.

Fruit firmness will be assessed on each individual mango by gentle hand pressure using a rating scale in which 1=fully soft, 2=advanced softness, 3=first softening, 4=firm to the touch, 5=very firm to the touch.

The shriveling of each individual mango will be assessed using a visual rating scale in which 1=extremely shriveled, wrinkled and dry, not acceptable under normal conditions; 2=severe shriveling, definitely, objectionable; 3=moderate, shriveling evident, becoming objectionable; 4=slight, minor signs of shriveling, not objectionable; 5=none, field fresh, no signs of shriveling.

The decay of each individual mango will be assessed using a modified visual rating scale from Horsfall and Barratt (1945) where 1=76-100% decay, severe to extreme decay (the mango is either partially or completely rotten); 2=51-75% decay, moderate to severe decay; 3=26-50% decay, slight to moderate decay (spots with decay and some mycelium growth); 4=1-25% decay, probable decay (brownish/grayish sunken minor spots); 5=0%, no decay.

### Results

As seen in peaches, the application of a mixture of S-ABA and methyl jasmonate is expectd to improve mango quality in a greater than expected amount as compared to the addition of the improved quality provided by application of each alone.

What is claimed is:

1. A method of improving post-harvest cold stress tolerance in a stone fruit comprising applying an effective amount of a mixture of(S)-abscisic acid (S-ABA) and a jasmonate to the stone fruit.

2. The method of claim 1, wherein the jasmonate is selected from the group consisting of jasmonic acid, methyl jasmonate and prohydrojasmon.

3. The method of claim 2, wherein the jasmonate is methyl jasmonate.

4. The method of claim 1, wherein application occurs from about 4 weeks prior to harvest to about 2 weeks after harvest.

5. The method of claim 4, wherein application occurs after harvest.

6. The method of claim 1, wherein the stone fruit is subjected to chilling temperatures following application.

7. The method of claim 6, wherein the chilling temperatures are from about 0.5 to about 15 degrees Celsius.

8. The method of claim 6, wherein fruit quality is improved compared to stone fruit that did not receive an application of the mixture of S-ABA and the jasmonate prior to being subjected to chilling temperatures.

9. The method of claim 1, wherein the mixture is applied at a concentration ratio from about 100:1 to about 1:100 S-ABA to the jasmonate.

10. The method of claim 9, wherein the mixture is applied at a concentration ratio from about 10:1 to about 1:10 S-ABA to the jasmonate.

11. The method of claim 10, wherein the mixture is applied at a concentration ratio from about 3:1 to about 1:3 S-ABA to the jasmonate.

12. The method of claim 1, wherein S-ABA is applied at a rate of from about 1 to about 5,000 parts per million.

13. The method of claim 1, wherein S-ABA is applied at a rate of from about 10 to about 1,000 parts per million.

14. The method of claim 1, wherein S-ABA is applied at a rate of from about 50 to about 1,000 parts per million.

15. The method of claim 1, wherein the jasmonate is applied at a rate of from about 1 to about 5,000 parts per million.

16. The method of claim 1, wherein the jasmonate is applied at a rate of from about 10 to about 1,000 parts per million.

17. The method of claim 1, wherein the jasmonate is applied at a rate of from about 50 to about 1,000 parts per million.

18. A method of improving fruit quality in stone fruit subjected to post-harvest chilling temperatures comprising applying an effective amount of a mixture of(S)-abscisic acid (S-ABA) and a jasmonate to the stone fruit.

19. The method of claim 18, wherein application occurs prior to the stone fruit being subjected to chilling temperatures.

20. The method of claim 18, wherein chilling temperatures are from about 0.5 to about 15 degrees Celsius.

21. The method of claim 18, wherein fruit quality is improved compared to stone fruit not receiving an application of the mixture of S-ABA and the jasmonate.
